(19) United States
(12) Patent Application Publication
(10) Pub. No.: US 2015/0112559 A1
(43) Pub. Date: Apr. 23, 2015

(54) Method for Executing Interleaved Gearshifts

(71) Applicant: ZF Friedrichshafen AG, Friedrichshafen (DE)

(72) Inventors: Markus Maurer, Lindau (DE); Christian Villing, Langenargen (DE)

(21) Appl. No.: 14/514,701

(22) Filed: Oct. 15, 2014

(30) Foreign Application Priority Data
Oct. 17, 2013 (DE) 10 2013 221 036.1

(51) Int. Cl. F16H 61/68; F16H 61/02

(52) U.S. Cl. CPC F16H 61/68; F16H 61/0202
USPC 701/58

(57) ABSTRACT

Method for executing gearshifts interlaced into each other in an automatic transmission with several shifting elements, whereas, upon the execution of gearshifts interlaced into each other, first shifting elements are open or switched off, and second shifting elements are closed or switched on, namely in such a manner that, as a second shifting element, at least one positive-locking shifting element is closed, whereby, with the activation of a positive-locking shifting element to be closed, there is a monitoring of whether, within a time interval after the activation of the particular positive-locking shifting element to be closed, the transmission ratio of the automatic transmission is within the tolerance band and is thus constant, and/or whether an end position sensor of the particular positive-locking shifting element to be closed detects a completely engaged position of the positive-locking shifting element to be closed, whereby, if at least one of these conditions is met, a proper closing of the particular positive-locking shifting element to be closed is detected, whereby if none of these conditions is met, an improper closing of the particular positive-locking shifting element to be closed is detected, and a substitute measure is initiated.

The invention relates to a method for executing gearshifts interlaced into each other. The invention also relates to a control device for carrying out the method.

It is already known from practice that, in automatic transmissions, a gear change may consist of gearshifts interlaced into each other. Such gearshifts interlaced into each other comprise highly dynamic gearshifts for reducing shifting times necessary for a gear change.

It is also already known from practice that, in automatic transmissions, positive-locking shifting elements are increasingly used as shifting elements. Compared to frictional-locking shifting elements, positive-locking shifting elements have the advantages of requiring less installation space and no frictional energy arising on them. However, such positive-locking shifting elements may be closed only in a narrow window of rotational speeds. If the positive-locking shifting element cannot be completely closed, it is subject to so-called “ratchets,” by which there is a significant risk of damage to the positive shifting element. Upon a gear change, under the involvement of at least one positive-locking shifting element, whether a positive-locking shifting element to be shifted or to be closed had been properly closed must be accordingly monitored. In particular, upon the execution of downshifts interlaced into each other under the closing of at least one previously open positive-locking shifting element, the detection of the full closing of the respective positive-locking shifting element causes difficulties.

On this basis, this invention is subject to the task of creating a new method for executing gearshifts interlaced into each other and a control device for carrying out the method.

This task is solved by a method for executing gearshifts interlaced into each other in accordance with claim 1.

In accordance with the invention, with the activation of a positive-locking shifting element to be closed, there is monitoring of whether, within a time interval after the activation of the particular positive-locking shifting element to be closed, the transmission ratio of the automatic transmission is within the tolerance band and is thus constant, and/or whether an end position sensor of the particular positive-locking shifting element to be closed detects a completely engaged position of the positive-locking shifting element to be closed, whereas if at least one of these conditions is met, a proper dosing of the particular positive-locking shifting element to be closed is detected, whereby if none of these conditions is met, an improper closing of the particular positive-locking shifting element to be closed is detected, and a substitute measure is initiated.

With the invention, upon the execution of gearshifts interlaced into each other, whether a positive-locking shifting element to be closed has been properly closed can be simply and reliably detected. If an improper closing of the particular positive-locking shifting element to be closed is detected, a substitute measure is initiated in order to protect the particular positive-locking shifting element to be closed from damage.

Preferably, as a substitute measure, the particular positive-locking shifting element to be closed for the opening and engaging of a substitute gear activates another shifting element for closing, whereas, preferably at the same time, the turning moment provided by the drive unit is reduced. By engaging the substitute gear, the availability of the automatic transmission can be increased. Through the reduction in the turning moment provided by the drive unit, the risk of damage to the transmission is further reduced.

Preferably, after the initiation of the substitute measure, whether the automatic transmission is blocked within a time interval is monitored, whereas, if a blocking of the automatic transmission is determined, the automatic transmission is transferred into neutral. Hereby, the risk of damage to the transmission can also be further reduced.

The control device in accordance with the invention is defined in claim 8.

Preferred additional forms arise from the sub-claims and the following description. Embodiments of the invention are, without any limitation, more specifically described by means of the drawing. Thereby, the following is shown:

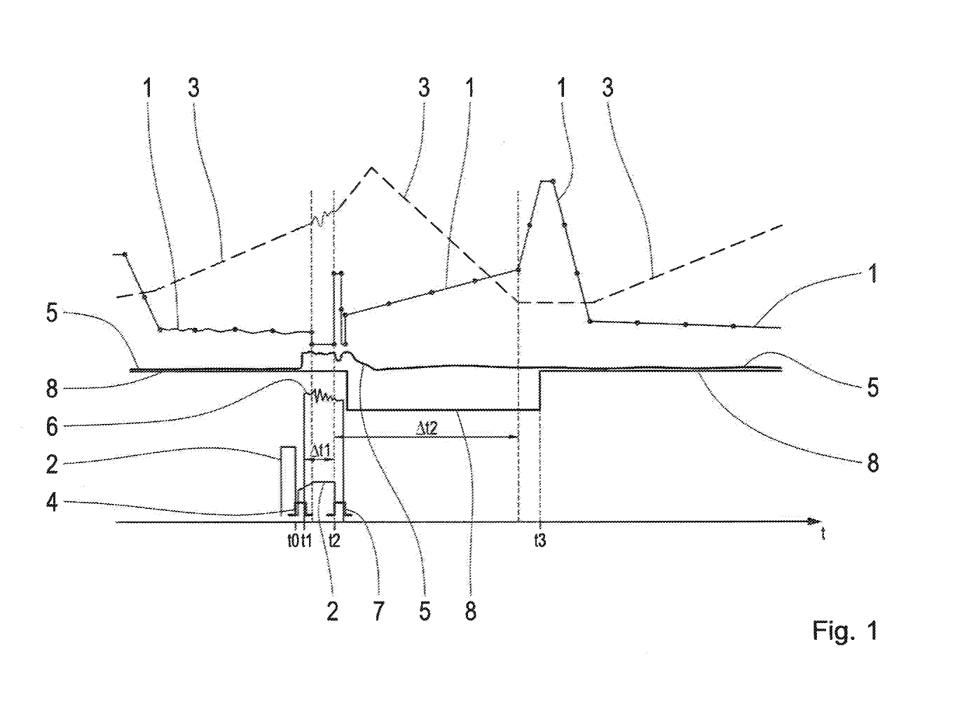

FIG. 1 a timing diagram to illustrate the method in accordance with the invention.

This invention relates to a method for executing gearshifts interlaced into each other on an automatic transmission and a control device for carrying out the method.

An automatic transmission includes several shifting elements formed as clutches or brakes, which can operate as frictionally locking or positively locking. Frictional-locking shifting elements are typically formed as multi-disk shifting elements. Positive-locking shifting elements are usually designed as claw couplings or claw brakes.

In each engaged gear, a first number of shifting elements of the transmission is open or switched off, and a second number of shifting elements of the transmission is closed or switched on. For the execution of a gear change, i.e., for the execution of a gear change of several gearshifts interlaced into each other, first shifting elements that were previously closed are opened and second shifting elements that were previously open are closed, whereas this invention relates to a method for executing gearshifts interlaced into each other, with which at least one previously opened positive-locking shifting element is closed upon the execution of the gearshift.

In terms of this invention, upon the execution of gearshifts interlaced into each other after the activation and/or with the activation of a positive-locking shifting element to be closed, there is a monitoring of whether, within a time interval after the activation of the particular positive-locking shifting element to be closed, the transmission ratio of the automatic transmission is within the tolerance band and is thus constant, and/or whether an end position sensor of the particular positive-locking shifting element to be closed detects a completely engaged position of the particular positive-locking shifting element to be closed.

If at least one of these conditions is met, a proper closing of the particular positive-locking shifting element to be closed is detected. If, on the other hand, none of these conditions is met, an improper closing of the particular positive-locking shifting element to be closed is detected, and a substitute measure is initiated, in order to prevent damage to the particular positive-locking shifting element to be closed.

As a substitute measure, the particular positive-locking shifting element to be closed is activated for opening, and preferably such that, at the same time or subsequently, another shifting element of the automatic transmission is activated for dosing, in order to engage a substitute gear in the automatic transmission.

Thereby, as a substitute gear, the original gear of the actual gearshifts interlaced into each other to be executed can be used, or a different substitute gear, in which the particular positive-locking shifting element to be closed is open, can be used.

At the same time with the activation of the positive-locking shifting element to be closed in an open position, the turning moment provided by the drive unit is reduced, in order to reduce the risk of damage to the automatic transmission.

Upon the engagement of a substitute gear, the reduced turning moment of the drive unit continues to be in effect, that is, until it is detected that the substitute gear is actually engaged. Subsequently, the reduced turning moment requirement for the drive unit can be canceled again.

After the initiation of the substitute measure, in particular after the activation of the shifting elements for engaging a substitute gear, whether the automatic transmission is blocked within a time interval is monitored.

If a blocking of the automatic transmission is determined, the automatic transmission is transferred into neutral through the activation of the shifting elements of the same.

FIG. 1 shows curve progressions that can be formed upon the execution of the method in accordance with the invention. Thus, with a curve progression 1 in FIG. 1, the pressure activation of a shifting element to be switched off or opened upon the execution of the gearshifts interlaced into each other is shown, whereas the chronological curve progression 2 shows the pressure activation of a positive-locking shifting element to be closed or switched on upon the execution of the gearshifts interlaced into each other. The gear change shown by example in FIG. 1 comprises a downshift, as can be found in the chronological curve progression 3, which shows a rotational speed curve.

In FIG. 1, prior to the point in time t0 in accordance with the curve progression 1, the shifting element to be opened, which comprises a frictional-locking shifting element in the embodiment that is shown, is at least partially opened, and, in accordance with the curve progression 2, the shifting element to be closed for the subsequent gearshift, which comprises a frictional-locking shifting element, is pre-filled.

At the point in time t0, in accordance with the activation pulse 4, the positive-locking shifting element to be closed is activated to dose.

In accordance with FIG. 1, beginning at the point in time t1 for the time interval Δt1, there is a monitoring of whether a transmission ratio of the automatic transmission is constant, whereas a chronological curve progression 5 shows the monitored transmission ratio of the automatic transmission.

Thereby, in FIG. 1, it is determined in the time interval Δt1 that the transmission ratio of the automatic transmission is not constant, i.e., it is outside of a tolerance band.

In addition, in the time interval Δt1, the signal of an end position sensor of the positive-locking shifting element to be closed is monitored. In FIG. 1, a curve progression 6 visualizes the signal of the end position sensor allocated to the positive-locking shifting element to be closed.

In FIG. 1, it is determined that the end position sensor allocated to the positive-locking shifting element to be closed does not detect any end position at the positive-locking shifting element to be closed.

Accordingly, in FIG. 1, during the time interval Δt1, it is determined that the positive-locking shifting element to be closed was not properly closed.

Therefore, beginning with the point in time t2, a substitute measure is initiated, i.e., in such a manner that, through the activation pulse 7, the particular positive-locking shifting dement to be closed is then activated to open, and the shifting element to be switched on prior lo being switched off (curve progression 2).

In addition, a substitute gear, preferably the original gear of the gearshifts interlaced into each other to be executed, continues to be engaged in the automatic transmission through a corresponding filling of the previously opened frictional-locking shifting element (see curve progression 1).

At the same time, in accordance with the curve progression 8, the turning moment provided by the drive unit, in order In ensure an additional protection from damages in the automatic transmission.

After initiating the substitute measure at the point in time t2, for a time interval Δt2, whether the automatic transmission is blocked as a result of the initiation of the substitute measure is monitored. For the monitoring of the blocking of the automatic transmission, the rotational speed on the side of the drive is monitored or evaluated.

If, during the time interval Δt2, no blocking of the automatic transmission is determined, i.e., if the engagement of the substitute gear is concluded, at the point in time t3 in FIG. 1, the reduced turning moment requirement for the drive unit 1 is canceled, such that the turning moment provided by the drive unit increases again in accordance with the curve progression 8.

If, however, during the time span Δt2, a blocking of the automatic transmission is determined, the automatic transmission is subsequently transferred into neutral.

Accordingly, in terms of this invention, upon the execution of gearshifts interlaced into each other, preferably with downshifts interlaced into each other, there is to be a monitoring of whether a positive-locking shifting element to be closed of the automatic transmission was properly closed, or whether the same could merely be transferred into an intermediate position.

For this purpose, on the one hand, the transmission ratio of the automatic transmission and, on the other hand, a measuring signal of an end position sensor, are monitored, If, after the activation of the positive-locking shifting element to be closed, it is determined during a time interval Δt1 that neither the transmission ratio of the automatic transmission is within the tolerance band and is thus constant, nor does the end position sensor detect an end position of the positive-locking shifting element to be closed, an improper closing of the respective positive-locking shifting element is closed and a substitute measure is initiated, i.e., preferably, the engagement of a substitute gear and the simultaneous lowering of the turning moment provided by the drive unit. This reduced turning moment requirement is canceled only if it is detected that the substitute gear could actually be engaged.

The invention further relates to a control device for carrying out the method in accordance with the invention. Preferably, the control device comprises a transmission control device for the control and/or regulation of the operation of a transmission, whereas the control device features instruments for carrying out the method in accordance with the invention. Such instruments comprise data interfaces, a data storage device and a processor. The data interfaces serve the purpose of communication and/or data exchange with the structural components involved in carrying out the method, such as the shifting elements and the end position sensors of the same. The data storage device serves the purpose of storing the data, and the processor serves the purpose of processing and/or evaluating the data.

### REFERENCE NUMERALS

1 Curve progression
2 Curve progression
3 Curve progression
4 Curve progression
5 Curve progression
6 Curve progression
7 Curve progression
8 Curve progression

1. Method for executing gearshifts interlaced into each other in an automatic transmission with several shifting elements, whereas, upon the execution of gearshifts interlaced into each other, first shifting elements are open or switched off, and second shifting elements are closed or switched on, namely in such a manner that, as a second shifting element, at least one positive-locking shifting element is closed, characterized in that, with the activation of a positive-locking shifting element to be closed, there is a monitoring of whether, within a time interval after the activation of the particular positive-locking shifting element to be closed, the transmission ratio of the automatic transmission is within the tolerance band and is thus constant, and/or whether an end position sensor of the particular positive-locking shifting element to be closed detects a completely engaged position of the positive-locking shifting element to be closed, that, if at least one of these conditions is met, a proper closing of the particular positive-locking shifting element to be closed is detected, whereby if none of these conditions is met, an improper closing of the particular positive-locking shifting element to be closed is detected, and a substitute measure is initiated.

2-8. (canceled)
